(19) United States
(12) Patent Application Publication
(10) Pub. No.: US 2024/0061676 A1
(43) Pub. Date: Feb. 22, 2024

(54) RELIABLE SYSTEM WITH REDUNDANT HARDWARE, AND SOFTWARE DERIVED FROM THE SAME SOURCE CODE BUT HAVING DIFFERENT BINARY EXECUTIONS

(71) Applicant: International Business Machines Corporation, Armonk, NY (US)

(72) Inventors: Bulent Abali, Tenafly, NJ (US); Hubertus Franke, Cortlandt Manor, NY (US); Paul Henri Muench, San Jose, CA (US); Kathryn M. O'Brien, South Salem, NY (US)

(21) Appl. No.: 17/893,053

(22) Filed: Aug. 22, 2022

(51) Int. Cl. G06F 8/71; G06F 8/51; G06F 8/30

(52) U.S. Cl. CPC G06F 8/71; G06F 8/51; G06F 8/30

(57) ABSTRACT

A computer-implemented method, in accordance with one embodiment, includes generating multiple versions of software from the same source code. Each of the versions is installed onto a corresponding, unique hardware system, the hardware systems being redundant relative to one another. When the versions are run on the respective hardware systems, the resulting respective executions of the versions are different.

### BACKGROUND

The present invention relates to system reliability, and more specifically, this invention relates to creating a reliable system having redundant hardware components, and software derived from the same source code but has different software binary images and different execution profiles.

Highly reliable and highly available systems attempt to eliminate failures by duplicating single-point-of-failure components. For example, some storage products duplicate hardware such that one hardware component survives if the other fails.

Some aerospace systems go even further and duplicate development of software as well as hardware in an attempt to eliminate common bugs. Software duplication in this context means generating functionally equivalent but independently developed software components, by independent companies or independent software teams. Unfortunately, developing multiple versions of software in parallel by different teams is cost prohibitive, and therefore impractical.

Software engineering techniques are also used in an attempt to increase software reliability and software security. For example, one software system implements probabilistic memory allocations to detect memory corruption and runs several replicas at once on the same host. However, such approaches are susceptible to a single point of hardware failure in the host.

### SUMMARY

A computer-implemented method, in accordance with one embodiment, includes generating multiple versions of software from the same source code. Each of the versions is installed onto a corresponding, unique hardware system, the hardware systems being redundant relative to one another. When the versions are run on the respective hardware systems, the resulting respective executions of the versions are different.

A computer program product, in accordance with one embodiment, includes one or more computer readable storage media, and program instructions collectively stored on the one or more computer readable storage media. The program instructions include program instructions to generate multiple versions of software from the same source code, and program instructions to install each of the versions onto a corresponding, unique hardware system, the hardware systems being redundant relative to one another. When the versions are run on the respective hardware systems, the resulting respective executions of the versions are different.

A system, in accordance with one embodiment, includes a processor, and logic integrated with the processor, executable by the processor, or integrated with and executable by the processor. The logic is configured to perform the foregoing method.

Other aspects and embodiments of the present invention will become apparent from the following detailed description, which, when taken in conjunction with the drawings, illustrate by way of example the principles of the invention.

### BRIEF DESCRIPTION OF THE DRAWINGS

FIG. 1 is a diagram of a computing environment, in accordance with one embodiment of the present invention.

FIG. 2 is a diagram of a tiered data storage system, in accordance with one embodiment of the present invention.

FIG. 3 is a diagram of a system architecture having redundant systems, in accordance with one embodiment of the present invention.

FIG. 4 is a flowchart of a method, in accordance with one embodiment of the present invention.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several preferred embodiments of systems, methods, and computer program products for implementing a reliable system with redundant hardware deployments running different instances of software that is derived from the same source code but compiled and/or executed differently so that a software failure is not encountered at the same time by the software instances running in parallel, thereby increasing reliability of the overall system.

In one general embodiment, a computer-implemented method includes generating multiple versions of software from the same source code. Each of the versions is installed onto a corresponding, unique hardware system, the hardware systems being redundant relative to one another. When the versions are run on the respective hardware systems, the resulting respective executions of the versions are different.

In another general embodiment, a computer program product includes one or more computer readable storage media, and program instructions collectively stored on the one or more computer readable storage media. The program instructions include program instructions to generate multiple versions of software from the same source code, and program instructions to install each of the versions onto a corresponding, unique hardware system, the hardware systems being redundant relative to one another. When the versions are run on the respective hardware systems, the resulting respective executions of the versions are different.

In another general embodiment, a system includes a processor, and logic integrated with the processor, executable by the processor, or integrated with and executable by the processor. The logic is configured to perform the foregoing method.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as block 200 having a version of software that is compiled and/or executed differently than a version of software, compiled from identical source code, which is running on a redundant system. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

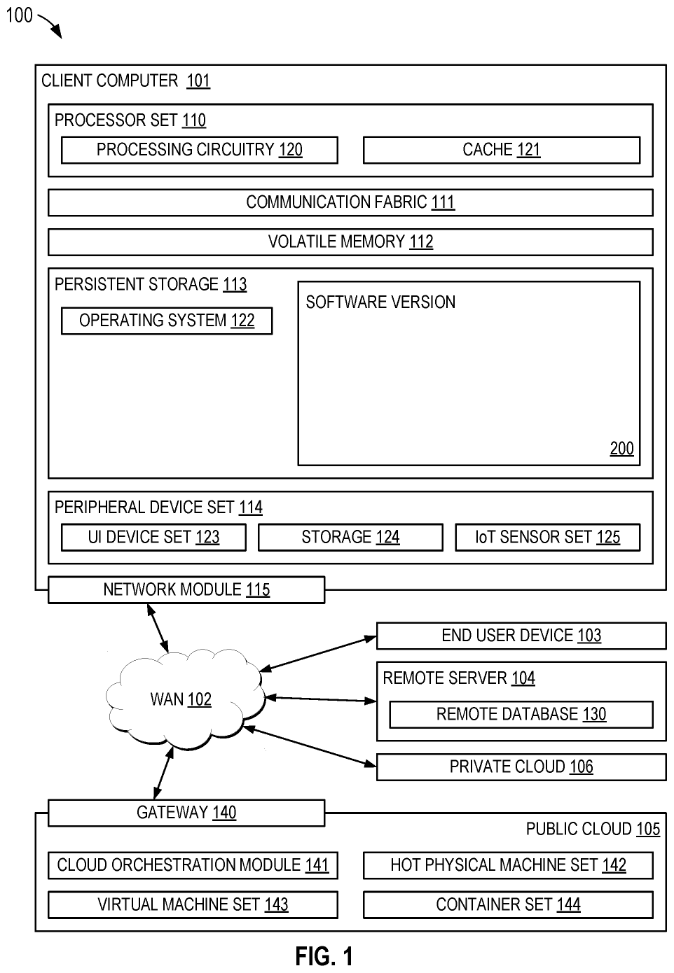

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

In some aspects, a system according to various embodiments may include a processor and logic integrated with and/or executable by the processor, the logic being configured to perform one or more of the process steps recited herein. The processor may be of any configuration as described herein, such as a discrete processor or a processing circuit that includes many components such as processing hardware, memory, I/O interfaces, etc. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

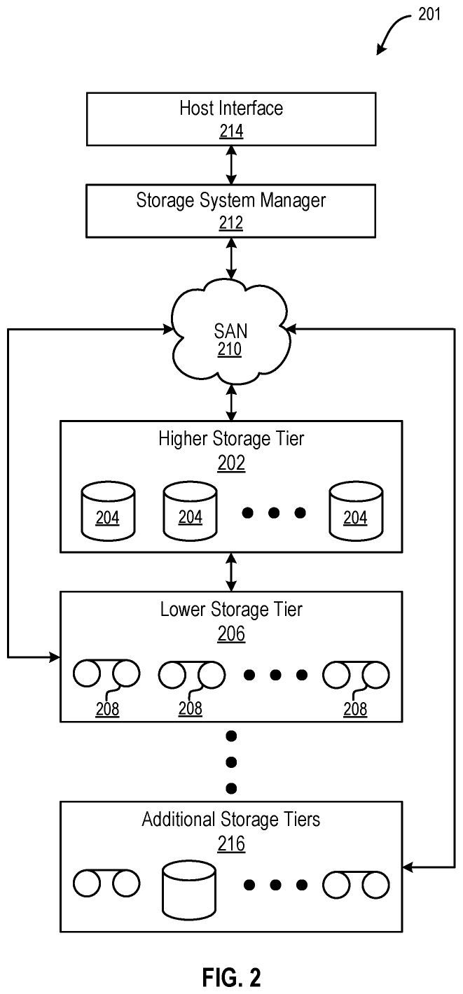

Now referring to FIG. 2, a storage system 201 is shown according to one embodiment. Note that some of the elements shown in FIG. 2 may be implemented as hardware and/or software, according to various embodiments. The storage system 201 may include a storage system manager 212 for communicating with a plurality of media and/or drives on at least one higher storage tier 202 and at least one lower storage tier 206. The higher storage tier(s) 202 preferably may include one or more random access and/or direct access media 204, such as hard disks in hard disk drives (HDDs), nonvolatile memory (NVM), solid state memory in solid state drives (SSDs), flash memory, SSD arrays, flash memory arrays, etc., and/or others noted herein or known in the art. The lower storage tier(s) 206 may preferably include one or more lower performing storage media 208, including sequential access media such as magnetic tape in tape drives and/or optical media, slower accessing HDDs, slower accessing SSDs, etc., and/or others noted herein or known in the art. One or more additional storage tiers 216 may include any combination of storage memory media as desired by a designer of the system 201. Also, any of the higher storage tiers 202 and/or the lower storage tiers 206 may include some combination of storage devices and/or storage media.

The storage system manager 212 may communicate with the drives and/or storage media 204, 208 on the higher storage tier(s) 202 and lower storage tier(s) 206 through a network 210, such as a storage area network (SAN), as shown in FIG. 2, or some other suitable network type. The storage system manager 212 may also communicate with one or more host systems (not shown) through a host interface 214, which may or may not be a part of the storage system manager 212. The storage system manager 212 and/or any other component of the storage system 201 may be implemented in hardware and/or software, and may make use of a processor (not shown) for executing commands of a type known in the art, such as a central processing unit (CPU), a field programmable gate array (FPGA), an application specific integrated circuit (ASIC), etc. Of course, any arrangement of a storage system may be used, as will be apparent to those of skill in the art upon reading the present description.

In more embodiments, the storage system 201 may include any number of data storage tiers, and may include the same or different storage memory media within each storage tier. For example, each data storage tier may include the same type of storage memory media, such as HDDs, SSDs, sequential access media (tape in tape drives, optical disc in optical disc drives, etc.), direct access media (CD-ROM, DVD-ROM, etc.), or any combination of media storage types. In one such configuration, a higher storage tier 202, may include a majority of SSD storage media for storing data in a higher performing storage environment, and remaining storage tiers, including lower storage tier 206 and additional storage tiers 216 may include any combination of SSDs, HDDs, tape drives, etc., for storing data in a lower performing storage environment. In this way, more frequently accessed data, data having a higher priority, data needing to be accessed more quickly, etc., may be stored to the higher storage tier 202, while data not having one of these attributes may be stored to the additional storage tiers 216, including lower storage tier 206. Of course, one of skill in the art, upon reading the present descriptions, may devise many other combinations of storage media types to implement into different storage schemes, according to the embodiments presented herein.

According to some embodiments, the storage system (such as 201) may include logic configured to receive a request to open a data set, logic configured to determine if the requested data set is stored to a lower storage tier 206 of a tiered data storage system 201 in multiple associated portions, logic configured to move each associated portion of the requested data set to a higher storage tier 202 of the tiered data storage system 201, and logic configured to assemble the requested data set on the higher storage tier 202 of the tiered data storage system 201 from the associated portions.

Of course, this logic may be implemented as a method on any device and/or system or as a computer program product, according to various embodiments.

Various embodiments of the present invention use redundant hardware systems, and also use versions of software compiled from the same source-code, but the binary and/or execution profiles of the respective versions are made different by implementing random processes and/or different compilation parameters to the effect of generating and/or executing two independent software binary components. Said another way, the runtime execution of software on parallel systems is made different by manipulating the software using different compilation tactics, and/or using the parameterization of the operating system running on the various systems to effectively change the timing of events when the software is running.

The independent binary and/or execution profiles increase system reliability by effectively masking common bugs in the same source code such that the chances of hitting the same bug at the same time are reduced.

Additionally, in some approaches, a software failure in the primary or in the secondary system is remembered and handled differently when the similar failures occur in the redundant system.

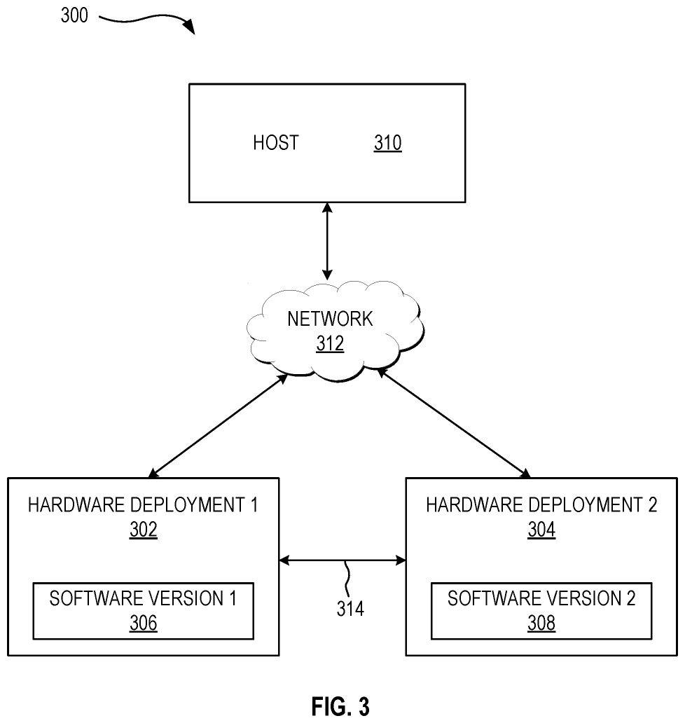

FIG. 3 depicts a system architecture 300 having redundant hardware systems 302, 304, each running a version of software 306, 308 compiled from the same source code, in accordance with one embodiment. As an option, the present system architecture 300 may be implemented in conjunction with features from any other embodiment listed herein, such as those described with reference to the other FIGS. Of course, however, such system architecture 300 and others presented herein may be used in various applications and/or in permutations which may or may not be specifically described in the illustrative embodiments listed herein. Further, the system architecture 300 presented herein may be used in any desired environment.

As noted above, the hardware systems 302, 304 are “redundant,” i.e., are configured to work concurrently to duplicate one or more desired tasks, e.g., data processing, serving data requests, storing data, etc. Note that while only two hardware systems are shown, more hardware systems may be present to provide additional redundancy, e.g., three, four, five, etc. Each of the hardware systems may have a version of the software thereon that has a unique binary image relative to the other versions. In other approaches, two of three or more systems may have identical versions of the software, while a third system has a unique version with a different binary image. Likewise, each of the systems may be configured alike, or one or more may be configured to introduce the variability in software execution described herein.

The hardware systems 302, 304 may be complete standalone systems that can perform desired tasks on their own, such as data processing, data storage, etc.

The hardware systems may be any type of computer-based system or portion thereof. In one exemplary embodiment, the systems 302, 304 are mirrored storage systems that process the same data requests provided by a host 310. For example, each of the systems 302, 304 may be an entire hierarchical storage system 201 as shown in FIG. 2.

In other approaches, the hardware systems 302, 304 are merely redundant components or sub-systems of a larger system. For example, the hardware systems 302, 304 may be a critical component of the larger system architecture for which hardening to hardware and software failures is desired. For example, each of the systems 302, 304 may be a tier of the hierarchical storage system 201 as shown in FIG. 2, the storage manger 212 of the hierarchical storage system 201, etc.

While any known redundant physical system configuration can be used, in one preferred approach, both systems are live and operating in parallel, with one of the systems 302 being the primary system and the other system 304 being the secondary system. A network 312, bus, or other communications mechanism may provide communication between the host 310 and the systems 302, 304.

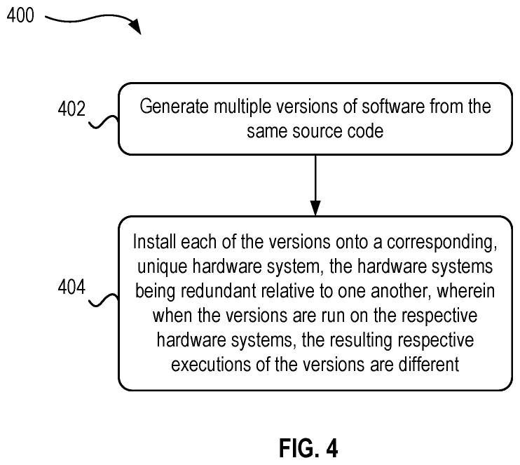

In operation, requests from the host are routed to both systems 302, 304, and each system 302, 304 processes the requests in parallel. The systems 302, 304 each run a version of software that is compiled from the same source code, but the binary and/or execution profiles of the respective versions are different, such that if a software error occurs, e.g., due to a bug in the source code, the systems avoid hitting the error at the same time. See, e.g., FIG. 4 and related description below.

With continued reference to FIG. 3, the primary system 302 services the requests from the host 310 until a failure occurs, upon which the secondary system 304 is used. In the approach shown, a redundancy link 314 between the systems 302, 304 is used in a known manner to coordinate which system 302, 304 responds to the host in the effect of a hardware and/or software failure. In other approaches, a coordinator in communication with the systems 302, 304 may control which system services requests from the host 310 in the event of a failure. Any conventional failover technique, that would become apparent to one skilled in the art after reading the present disclosure, may be used to coordinate the transition from one system to the other as needed in the event of a hardware and/or software failure.

In addition, as described in more detail below, in the event a failure occurs in the primary system 302, the redundancy link 314, coordinator, etc. may be used to cause the secondary system 304 to take corrective action to avoid such failure.

Now referring to FIG. 4, a flowchart of a method 400 for creating a highly reliable and available system which eliminates single points of failure is shown according to one embodiment. The method 400 may be performed in accordance with the present invention in any of the environments depicted in FIGS. 1-3, among others, in various embodiments. Of course, more, or fewer operations than those specifically described in FIG. 4 may be included in method 400, as would be understood by one of skill in the art upon reading the present descriptions.

Each of the steps of the method 400 may be performed by any suitable component of the operating environment. For example, in various embodiments, the method 400 may be partially or entirely performed by a storage system or some other device having one or more processors therein. The processor, e.g., processing circuit(s), chip(s), and/or module(s) implemented in hardware and/or software, and preferably having at least one hardware component may be utilized in any device to perform one or more steps of the method 400. Illustrative processors include, but are not limited to, a central processing unit (CPU), an application specific integrated circuit (ASIC), a field programmable gate array (FPGA), etc., combinations thereof, or any other suitable computing device known in the art.

As shown in FIG. 4, method 400 may initiate with operation 402, where multiple versions of software are generated from the same source code.

Referring to operation 404, each of the versions is installed onto a corresponding, unique hardware system. The hardware systems are redundant relative to one another, e.g., may have identical hardware configurations or essentially identical hardware configurations. When the software versions are run on the respective hardware systems, even though the same effective transactions are produced by the instances, the resulting respective executions of the versions are different such that, if an error (failure) occurs, the software avoids hitting the same software error at the same time even though the versions are executed concurrently. Thus, by slightly altering the way the two versions execute at runtime, a failure due to a bug in the source code that is encoded into the software can be prevented from appearing on systems of the redundant system architecture at the same time.

In one approach, the versions have different executable binary images relative to one another. Any technique, for creating versions that have different binary images, that would become apparent to one skilled in the art after reading the present descriptions may be used. In one exemplary approach, differing versions of software may be generated from the same source code by using differing compiler settings, thereby creating two versions of the software having the different binary images relative to one another. One or more parameters of the compiler may be changed when compiling the second version of the software from the same source code. Examples include changing the optimization setting on the compiler, e.g., so that the compiler will not implement some things, such as loop enrolling, aggressive prefetching of data, etc. Another option includes selecting certain prefixes or post fixes when enter into or exit from functions that will be generated in different ways, different locations, and so on. Yet another option may include changing one or more timing constants when compiling one of the versions. The resulting binary images will then have different characteristics, such as one or more of size, layout, instruction stream, etc.

In another approach, different version may be created from the same source code by using different compilers, e.g., different types of compilers developed by different software teams and companies. In the exemplary embodiment, the different code versions 306 and 308 may run on the different hardware systems 302 and 304.

In another aspect, the software versions are identical, but execution thereof is performed such that the versions have different execution profiles relative to one another. Any technique, for varying the execution profiles of the respective versions, that would become apparent to one skilled in the art after reading the present descriptions may be used. In one exemplary approach, the software may be run on different types of operating systems on the respective systems, e.g., one system 302 may run the software 306 in AIX and another system 304 may run the software 308 in Linux. Moreover, the operating system on each system may be native, or run via virtual machine within the system. In another example, each system has a different hardware platform, such as PowerPC on one system 302 and x86 on the other system 304. In a further approach, the systems may implement different run times with respect to each other. In yet another approach, a combination of the foregoing may be implemented in the systems.

In some aspects, variability is introduced in one or more of the systems, which creates timing differences in the respective systems. This is beneficial in that the variability can be introduced without changing the code, though variability may also be introduced where software versions have different binary images. Examples of how to apply variability in different systems follow.

In one aspect, address space layout randomization is implemented. This feature is particularly useful for detecting and recovering from pointer bugs and buffer overruns. In one approach, the address space layout comprised of various segments such as code, heap, and data, is randomized at loading time by the respective systems, thereby introducing slight variations in the way the respective version of software runs on the associated system. In another approach the address space layout is further randomized at runtime when new address space segments are dynamically requested by the program through interfaces like mmap( ).

Another approach utilizes randomized memory allocation from the heap, e.g., malloc( ), is used to allocate a block of heap memory. A malloc( ) function reserves a memory space for a specified size and returns a pointer, which points to the memory location of the specified size. For a P=malloc(m) implementation, a random variable R is added to the specified size (m), such that memory allocation uses malloc(m+R). Preferably R is small in units of minimum allocation size, e.g., 16 to 32 bytes; and slightly larger blocks may be allocated on occasion. Memory blocks are allocated from different offsets on the heap on the two systems. Over time, the small random differences will add up to P being substantially far off on the two systems.

In another approach using address space layout randomization, randomized free( ) is used. The free (P) implementation internally queues address P in a small queue (e.g., 2-3 entry) of to be freed memory blocks. The actual free( ) randomly picks one of the 2-3 memory blocks on the same queue and frees it. Effectively, this reorders the sequence of blocks being freed. Over a period, the systems' malloc/free address layouts will diverge.

In one aspect, operating system scheduler randomization is implemented to vary, stagger, etc. the ordering of the software processes so that a failure is not encountered by all instances of the software at the same time. This feature is particularly useful for detecting and recovering from concurrency bugs and deadlocks.

In one approach using operating system scheduler randomization, parameters in the scheduler are modified in such a way that the schedules of the systems vary slightly. For instance, the scheduler in each system may provide a different quantum, which specifies how long a process can run, a thread can run uninterrupted, or until the process or thread effectively gives the CPU up for some reason, e.g., due to I/O. Accordingly, the systems have different interaction with the threads that are currently running.

The scheduler may use any singular or combination of techniques to introduce the variations in scheduling. Examples include inserting random delays and context switches; randomly changing thread priorities, e.g., add plus 1 or minus 1 to thread priority randomly; randomly change the scheduling periods, e.g., quantum change: 4 ms on one system and 5 ms on the other system; make minor variations in the control groups (CGROUPS) apportionment; randomly reorders tasks on the scheduler queues; and causing the workload to insert random delays before yielding the processor.

Another approach using operating system scheduler randomization entails cycling through a predefined set of parameters on the respective systems. For example, any of the foregoing parameters may be part of a script.

In yet another aspect, input/output (I/O) scheduler randomization is implemented. This feature is particularly useful for detecting and recovering from I/O device firmware bugs.

In one approach using I/O scheduler randomization, the order of I/O tasks in the I/O queue is randomly changed.

In another approach, the anticipatory read/write deadlines of algorithms are changed. Reads typically have a much shorter deadline than writes. Changes to these deadlines basically changes the dynamics of when the data becomes read, which in turn changes how the respective applications and threads continue.

A recovery technique may be used to maintain uptime and continued operation in the event of a hardware and/or software failure on the primary system, preferably with minimal or no downtime, and minimal or no data loss. Any known type of recovery technique that would become apparent to one skilled in the art after reading the present disclosure may be used. Thus, for example, because the executions of the various instances of software are different, a failure encountered by one system will occur a short time before the failure is encountered by another system provides a window for recovery within (and perhaps slightly beyond) that short time period. Even a one second delay between encountering the errors is an advantage which could enable a failover and essentially uninterrupted service.

In one embodiment, a software failure is detected in a first of the hardware systems during runtime, and in response thereto, a change is made to avoid the failure.

In one aspect, a second of the hardware systems behaves differently for reducing an impact of a same software error on the second hardware system. In one approach, the different behavior includes reacting to the software failure in a different manner than the first system reacted to the error. In another approach, the different behavior includes modifying execution of the version running in the second hardware system in an attempt to avoid the software failure in the second hardware system. For example, the system 300 may suspend I/O traffic from host 310 in anticipation of failure of the second system 304. Although no I/O can be performed further, this action will guarantee that no host data will be lost, and the host can take the necessary recovery action separately. In another example, the second system may enter in to a “safe mode” in which the second system acknowledges the host 310's I/O requests only if the requests can be completely processed and with no data loss. Although, the I/O performance may be degraded in the safe mode, it will guarantee that no host data will be lost.

In another aspect, a repeated software failure is detected in the primary hardware system when the primary hardware system performs a particular task. For example, the failure may occur each time the hardware system performs the task. In response to determining that a secondary one of the hardware systems does not experience the same failure when performing the task, the secondary hardware system is used as the primary provider of the task. The primary hardware system may remain the primary provider for other tasks except for the problematic task.

There have thus been described a methodology and system architecture that overcomes many deficiencies in the art. For example, basic functional errors in a software system are usually discoverable by testing. However, timing errors have been a challenge to discover, as they are very difficult to find and fix, especially in a system that is deployed and in use, e.g., at a customer site. However, because a system architecture that implements the teachings herein whereby the timing characteristics of software running in parallel are different, one version of software is now able to function as a backup for another version, even though both were compiled from the same source code and thus would likely encounter the same bug.

It will be clear that the various features of the foregoing systems and/or methodologies may be combined in any way, creating a plurality of combinations from the descriptions presented above.

It will be further appreciated that embodiments of the present invention may be provided in the form of a service deployed on behalf of a customer to offer service on demand.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
generating multiple versions of software from the same source code;
installing each of the versions onto a corresponding, unique hardware system, the hardware systems being redundant relative to one another,
wherein when the versions are run on the respective hardware systems, the resulting respective executions of the versions are different.

2. The computer-implemented method of claim 1, wherein the versions have different executable binary images relative to one another.

3. The computer-implemented method of claim 2, wherein generating the multiple versions of software from the same source code includes using differing compiler settings for compiling respective versions of software.

4. The computer-implemented method of claim 2, wherein generating the multiple versions of software from the same source code includes using different compilers for compiling different versions of software.

5. The computer-implemented method of claim 1, wherein the versions are identical, wherein the running is performed such that the versions have different execution profiles relative to one another.

6. The computer-implemented method of claim 5, wherein at least two of the hardware systems use different types of operating systems relative to one another to run the version associated therewith.

7. The computer-implemented method of claim 1, wherein at least two of the hardware systems use different types of operating systems relative to one another to run the version associated therewith.

8. The computer-implemented method of claim 1, wherein the hardware systems have identical hardware configurations.

9. The computer-implemented method of claim 1, comprising implementing address space layout randomization.

10. The computer-implemented method of claim 1, comprising implementing operating system scheduler randomization.

11. The computer-implemented method of claim 1, comprising input/output scheduler randomization.

12. The computer-implemented method of claim 1, comprising detecting a software failure in a first of the hardware systems during runtime, and causing a second of the hardware systems to behave differently for reducing an impact of a same software error on the second hardware system.

13. The computer-implemented method of claim 12, wherein the different behavior includes reacting to the software failure in a different manner.

14. The computer-implemented method of claim 12, wherein the different behavior includes modifying execution of the version running in the second hardware system in an attempt to avoid the software failure in the second hardware system.

15. The computer-implemented method of claim 1, comprising detecting a repeated software failure in a primary one of the hardware systems when the primary hardware system performs a particular task; determining that a secondary one of the hardware systems does not experience the same failure when performing the task; and using the secondary hardware system as the primary provider of the task.

16. A computer program product, the computer program product comprising:
one or more computer readable storage media, and program instructions collectively stored on the one or more computer readable storage media, the program instructions comprising:
program instructions to generate multiple versions of software from the same source code; and
program instructions to install each of the versions onto a corresponding, unique hardware system, the hardware systems being redundant relative to one another,
wherein when the versions are run on the respective hardware systems, the resulting respective executions of the versions are different.

17. The computer program product of claim 16, wherein the versions have different executable binary images relative to one another.

18. The computer program product of claim 16, wherein the versions are identical, wherein the running is performed such that the versions have different execution profiles relative to one another.

19. The computer program product of claim 18, comprising implementing a procedure selected from the group consisting of: address space layout randomization, operating system scheduler randomization, and input/output scheduler randomization.

20. A system, comprising:
a processor; and
logic integrated with the processor, executable by the processor, or integrated with and executable by the processor, the logic being configured to:
generate multiple versions of software from the same source code;
install each of the versions onto a corresponding, unique hardware system, the hardware systems being redundant relative to one another,
wherein when the versions are run on the respective hardware systems, the resulting respective executions of the versions are different.
